(19) United States
(12) Patent Application Publication
(10) Pub. No.: US 2026/0298642 A1
(43) Pub. Date: Oct. 1, 2026

(54) MIXED REACHABILITY ASSESSMENT ROUTE VALIDATION

(71) Applicant: THE BOEING COMPANY, Arlington, VA (US)

(72) Inventor: Max L. Greene, Cambridge, MA (US)

(21) Appl. No.: 19/090,772

(22) Filed: Mar. 26, 2025

(51) Int. Cl. G01C 21/34; G06Q 10/047

(52) U.S. Cl. CPC G01C 21/3415; G06Q 10/047

(57) ABSTRACT

A method includes obtaining a first planned route of travel of an interceptor. The method further includes performing a forward reachability assessment from the interceptor along the first planned route, in association with an initial target, to generate a forward reachability zone. The method further includes performing a backward reachability assessment from the initial target to generate a backward reachability zone. The method further includes generating a first reachability metric that indicates a likelihood of the interceptor reaching the initial target within a specified time. The method further includes obtaining a validation route of the interceptor toward a selected target, wherein the validation route is based on the first reachability metric.

### STATEMENT OF GOVERNMENT INTEREST

This invention was made with government support under Contract Number N6523623C8011 awarded by DARPA. The U.S. government has certain rights in the invention.

### FIELD OF THE DISCLOSURE

The present disclosure is generally related to routing validation systems, and more particularly, to systems and methods for validating a planned route of travel of an interceptor toward a target using a mixed reachability assessment.

### BACKGROUND

Feasibility assessments are used to determine whether an interceptor, such as a vehicle or a missile, will reach a target within a specified amount of time. Some systems use forward or backward reachability calculations to identify potential for the interceptor to reach the target. Forward reachability calculations (e.g., calculations that show locations an interceptor can reach within the specified amount of time) express potential interception areas forward-in-time. However, forward reachability calculations become increasingly conservative about the likelihood of the interceptor to reach the target the further forward in time considered. Additionally, forward reachability calculations tend to be increasingly computationally expensive. Backward reachability calculations (e.g., calculations that show locations an interceptor can be and still reach the target within the specified amount of time) express potential interceptor locations backward-in-time. Backward reachability calculations also become increasingly conservative and computationally expensive the further backward in time considered. In some cases, backward reachability calculations can be precalculated, mitigating a computation cost associated with the backward reachability calculations. However, some backward reachability calculations use information regarding a target (e.g., an expected position of the target after the specified amount of time) that is not yet available at a precalculation time (e.g., because the target has not yet been identified). Further, in some cases, some precalculated backward reachability calculations assume a worst-case scenario that does not occur (e.g., the presence of an automobile accident along a route of an automobile to a destination).

As a result, it can be difficult to identify a probability for the interceptor to reach the target along a planned route using either a forward reachability calculation or a backward reachability calculation in a situation where interception is possible but not guaranteed. Accordingly, it is desirable to reduce the computational expense of performing a feasibility assessment. Further, it is desirable to analyze a planned route and identify a likelihood of an interceptor reaching a target using a planned route within a specified time.

### SUMMARY

In a particular implementation, a method includes obtaining a first planned route of travel of an interceptor. The method also includes performing a forward reachability assessment from the interceptor along the first planned route, in association with an initial target, to generate a forward reachability zone. The method also includes performing a backward reachability assessment from the initial target to generate a backward reachability zone. The method also includes generating a first reachability metric that indicates a likelihood of the interceptor reaching the initial target within a specified time. The method also includes obtaining a validation route of the interceptor toward a selected target, wherein the validation route is based on the first reachability metric.

In a particular implementation, an interceptor includes a memory configured to store a first planned route of travel and one or more processors coupled to the memory. The one or more processors are configured to perform a forward reachability assessment along the first planned route in association with a target to generate a forward reachability zone. The one or more processors are further configured to perform a backward reachability assessment from the target to generate a backward reachability zone. The one or more processors are further configured to generate a reachability metric that indicates a likelihood of reaching the target within a specified time. The one or more processors are further configured to, in response to the reachability metric failing to satisfy a reachability threshold, generate a validation route, wherein the validation route is based on the reachability metric, and store the validation route at the memory.

According to another implementation of the present disclosure, a controller includes a memory configured to store a first planned route of travel of a first interceptor and one or more processors coupled to the memory. The one or more processors are configured to perform a forward reachability assessment for the first interceptor along the first planned route in association with a first target to generate a forward reachability zone. The one or more processors are further configured to perform a backward reachability assessment from the first target to generate a backward reachability zone. The one or more processors are further configured to generate a first reachability metric that indicates a likelihood of the first interceptor reaching the first target within a specified time. The one or more processors are further configured to, in response to the first reachability metric failing to satisfy a reachability threshold, generate a first validation route for the first interceptor, wherein the first validation route is based on the first reachability metric, store the first validation route at the memory, and send the first validation route to the first interceptor.

The features, functions, and advantages described herein can be achieved independently in various implementations or can be combined in yet other implementations, further details of which can be found with reference to the following description and drawings.

### BRIEF DESCRIPTION OF THE DRAWINGS

FIG. 1 is a diagram that depicts two portions of a first example mixed reachability assessment to validate a planned route of travel of an interceptor in association with a target.

FIG. 2 is a diagram that depicts two additional portions of the first example mixed reachability assessment to validate a planned route of travel of an interceptor in association with a target.

FIG. 3 is a diagram that depicts two portions of a second example mixed reachability assessment to validate a planned route of travel of an interceptor in association with a target.

FIG. 4 is a diagram that depicts two portions of a third example mixed reachability assessment to validate a planned route of travel of an interceptor in association with a target.

FIG. 5 is a diagram that depicts two portions of an example mixed reachability assessment to validate a plurality of planned routes of travel of a plurality of interceptors in association with a plurality of targets.

FIG. 6 is a flowchart of a method of validating a planned route of travel of an interceptor in association with a target using a mixed reachability assessment.

FIG. 7 is a block diagram of a computing environment including a computing device configured to support aspects of computer-implemented methods and computer-executable program instructions (or code) according to the present disclosure.

### DETAILED DESCRIPTION

Systems and methods are described herein that perform a mixed reachability assessment to validate a planned route of travel of an interceptor (e.g., an automobile, an aircraft, a boat, a missile, a drone, a pedestrian, etc.) in association with an initial target (e.g., a location, a destination object, a second interceptor, etc.). The mixed reachability assessment includes a forward reachability assessment along the planned route and a backward reachability assessment from the initial target. A reachability metric is generated using the mixed reachability assessment to identify a likelihood of the interceptor reaching the initial target within the specified time. A validation route is generated toward a selected target based on the reachability metric, where the validation route is the planned route or a different route, and where the selected target can be the initial target or a different target. The interceptor is controlled using the validation route. For example, the validation route can be used to generate one or more control signals to control actuators onboard the interceptor, engines or thrusters onboard the actuator, or other components of the interceptor that control the direction of travel and/or speed of the interceptor.

In some implementations, the forward reachability assessment generates a forward reachability zone that indicates locations the interceptor can reach within the specified time. The backward reachability assessment generates a backward reachability zone that indicates locations that can reach the initial target within the same specified time or another specified time. The reachability metric is generated by looking for intersections or overlapping locations between the forward reachability zone and the backward reachability zone. The planned route is compared to a probability mass of the intersections of the reachability metric to identify a likelihood of the interceptor reaching the target by following the planned route. As further discussed below, a probability is assigned to the interceptor reaching various locations within respective amounts of time. The planned route is compared to the intersections and then the probabilities along the planned route are summed to determine the probability mass. Accordingly, the mixed reachability assessment provides a likelihood of the interceptor reaching the target by following the planned route and a likelihood of the interceptor reaching the target. In some implementations, the likelihood of the interceptor reaching the target by following the planned route is used to determine whether the interceptor should use a different route to reach the target. In some implementations, the likelihood of the interceptor reaching the target is used to determine whether the interceptor should change to a new target or whether an alert should be provided to a user.

The computation expense of computing forward reachability increases as distance from the interceptor increases. Similarly, computational complexity of the backward reachability assessment increases as distance from the target increases. In some implementations, the forward reachability assessment covers only a portion of a distance between the interceptor and the initial target. Similarly, in some implementations, the backward reachability assessment covers only a portion of the distance between the interceptor and the initial target. Intersections between the forward reachability assessment and the backward reachability assessment are identified. In some implementations, both performing a forward reachability assessment that only covers a portion of the distance between the interceptor and the initial target and performing a backward reachability assessment that only covers a portion of the distance between the interceptor and the initial target is less computationally expensive, as compared to performing either a forward reachability assessment or a backward reachability assessment between the interceptor and the initial target.

In some implementations, the mixed reachability assessment can be less conservative in estimating locations the interceptor will be able to reach within a portion of the specified time, as compared to a forward reachability assessment that covers an entire distance between the interceptor and the initial target. Because the mixed reachability assessment is looking for overlap between the forward reachability assessment and the backward reachability assessment rather than projecting the forward reachability assessment further ahead in time, the mixed reachability assessment can rule out one or more situations that would be otherwise considered. Similarly, the mixed reachability assessment can also be less conservative than a backward reachability assessment that covers an entire distance between the initial target and the interceptor. As a result, the mixed reachability assessment is less conservative and provides tighter reachability bounding boxes, as compared to performing only a forward reachability assessment or only a backward reachability assessment. Further, in some cases, because some situations are not considered, computational complexity is reduced.

In some implementations, a validation route is used as opposed to directing the interceptor to always follow an optimized route to the initial target. In some implementations, if the likelihood of the interceptor reaching the initial target satisfies a reachability threshold, the validation route is the same as the planned route. As a result, even though a desired likelihood of the interceptor reaching the initial target is enforced, additional factors can be considered at the interceptor (e.g., an aircraft is not directed to steer into the flight path of another aircraft to follow a slightly more optimized route). Further, the interceptor is not repeatedly pressured to change route if one or more items (e.g., a storm) are detected that makes the planned route slower but without causing the likelihood of the interceptor reaching the initial target to fail to satisfy the reachability threshold.

The figures and the following description illustrate specific exemplary implementations. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific implementations or examples described below, but by the claims and their equivalents. Particular implementations are described herein with reference to the drawings. In the description, common features are designated by common reference numbers throughout the drawings.

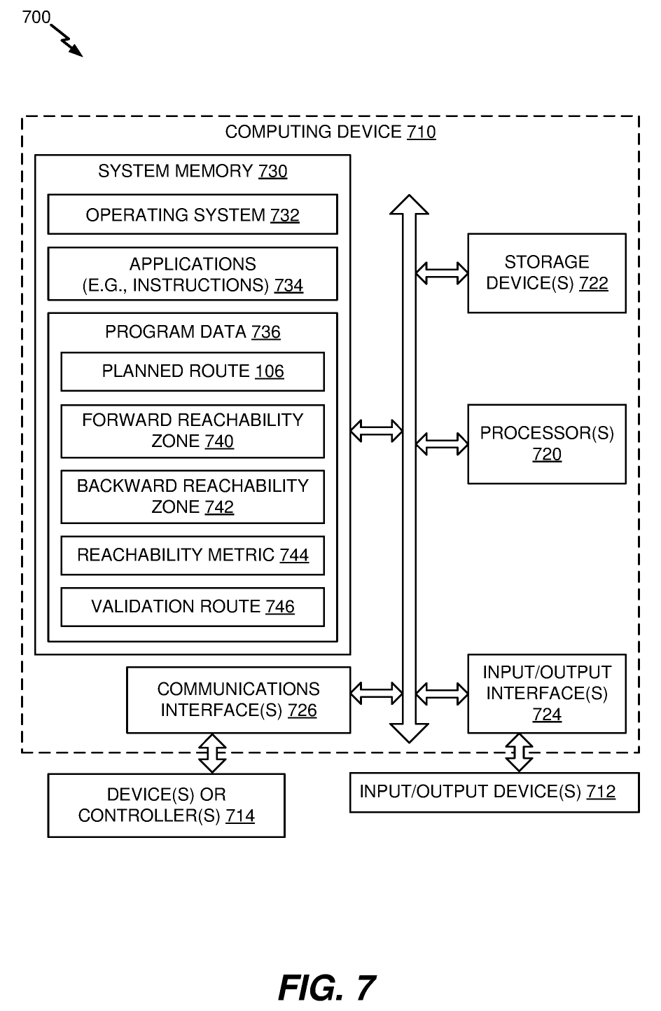

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 7 depicts a computing device 710 including one or more processors (“processor(s)” 720 in FIG. 7), which indicates that in some implementations the computing device 710 includes a single processor 720, and in other implementations the computing device 710 includes multiple processors 720. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

Within this disclosure, in some cases, different entities (which are variously referred to as “components,” “units,” “devices,” etc.) are described or claimed as “configured” to perform one or more tasks or operations. This formulation-[entity] configured to [perform one or more tasks]-is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Further, the term “configured to” is not intended to mean “configurable to.” An unprogrammed field-programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

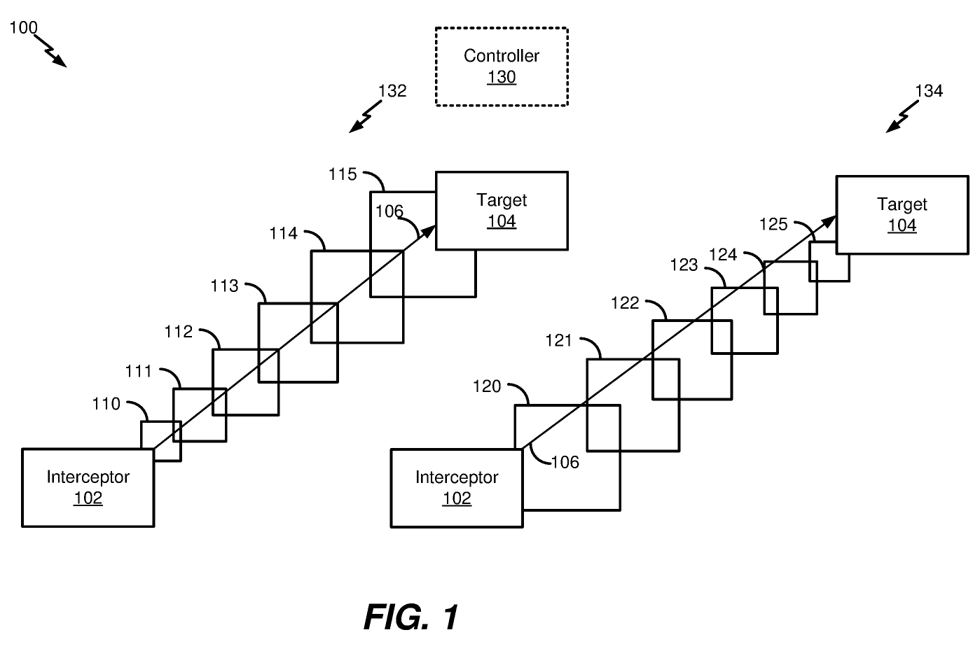

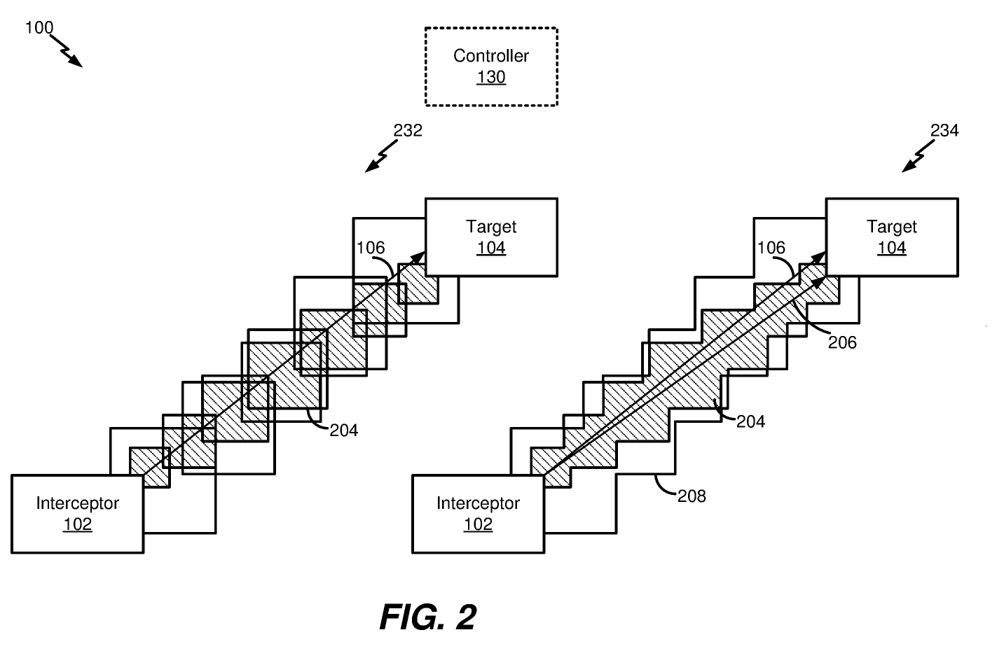

FIGS. 1 and 2 collectively illustrate portions of a first example 100, which are depicted separately for clarity. In FIGS. 1 and 2, elements having a same reference number are intended to be interpreted as being the same element. In some implementations, operations corresponding to portions 132, 134, 232, and 234 of the first example 100 are performed sequentially. In other implementations, some or all of the operations corresponding to the portions 132, 134, 232, and 234 are performed in parallel or concurrently.

FIG. 1 is a diagram that illustrates two portions of a first example 100 mixed reachability assessment to validate a planned route of travel of an interceptor in association with a target. In FIG. 1, the first example 100 includes a first portion 132, a second portion 134, and a controller 130. The first portion 132 and the second portion 134 depict respective analysis performed between an interceptor 102 and a target 104. Additionally, the first portion 132 and the second portion 134 depict a planned route 106 of the interceptor 102. The planned route 106 is depicted as a straight line for simplicity and clarity, but one of ordinary skill would understand that, in some cases, the planned route 106 can be more complicated (e.g., involving turns).

The first portion 132 depicts a plurality of volumes 110, 111, 112, 113, 114, and 115 identified by a forward reachability assessment along the planned route 106 in association with the target 104 (e.g., in association with a location of the target 104). Each volume 110-115 represents a group of locations that the interceptor 102 can reach by a respective time. In the illustrated implementation, the volume 110 represents an earliest time and the volume 115 represents a latest time. As a result, the volume 110 is the smallest of the plurality of volumes 110-115 and the volume 115 is the largest of the plurality of volumes 110-115. In some implementations, the largest volume (the volume 115) corresponds to a specified duration or time within which the interceptor is to reach the target 104. Further, the volume 110 is the least computationally expensive to compute and the volume 115 is the most computationally expensive to compute. The collective area identified by the plurality of volumes of the forward reachability assessment (e.g., the volumes 110-115) is referred to herein as a “forward reachability zone.”

In some implementations, the forward reachability assessment is performed using a “probability mass.” The plurality of volumes 110-115 represent concretized distributions of the probability of the interceptor 102 reaching corresponding locations by a plurality of corresponding times. In some cases, a standard deviation used to concretize the distributions varies based on a threshold varies (e.g., by 2 standard deviations or 5 standard deviations). In various implementations, different respective types of probabilistic distributions are used (e.g., uniform, Gaussian, etc.).

The second portion 134 depicts a plurality of volumes 120, 121, 122, 123, 124, and 125 identified by a backward reachability assessment. Each volume 120-125 represents a group of locations from which the target 104 can be reached by a respective time. In the illustrated implementation, the volume 120 represents an earliest time and the volume 125 represents a latest time. As a result, the volume 125 is the smallest of the plurality of volumes 120-125 and the volume 120 is the largest of the plurality of volumes 120-125. In some implementations, the largest volume (the volume 120) corresponds to a specified duration or time within which the interceptor 102 is to reach the target 104. Further, the volume 125 is the least computationally expensive to compute and the volume 120 is the most computationally expensive to compute. The collective area identified by the plurality of volumes of the backward reachability assessment (e.g., the volumes 120-125) is referred to herein as a “backward reachability zone.” In some implementations, the backward reachability assessment is performed in association with a location of the interceptor 102. In some implementations, the backward reachability assessment is precomputed prior to the specified time. However, in some cases, the backward reachability assessment cannot be precomputed (e.g., because the target 104 is not identified before the specified time or because of potential obstacles (e.g., pedestrians or traffic) that cannot be identified before the specified time).

In some implementations, the backward reachability assessment is performed using a “probability mass.” The plurality of volumes 120-125 represent concretized distributions of the probability of the target 104 being reached from corresponding locations by a plurality of corresponding times. In some cases, a standard deviation used to concretize the distributions varies based on a threshold varies (e.g., by 2 standard deviations or 5 standard deviations). In various implementations, different respective types of probabilistic distributions are used (e.g., uniform, Gaussian, etc.).

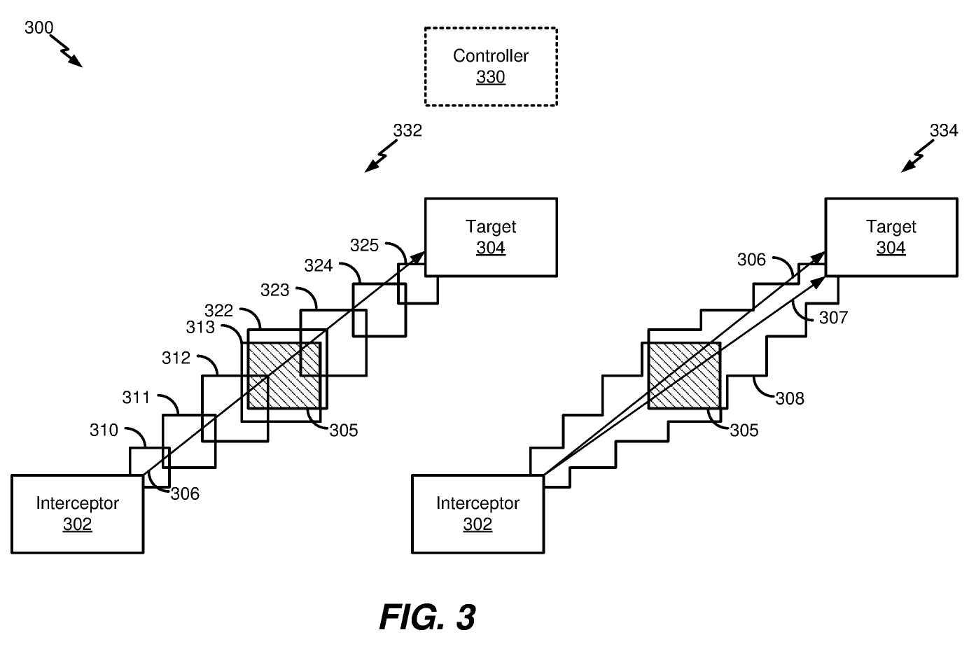

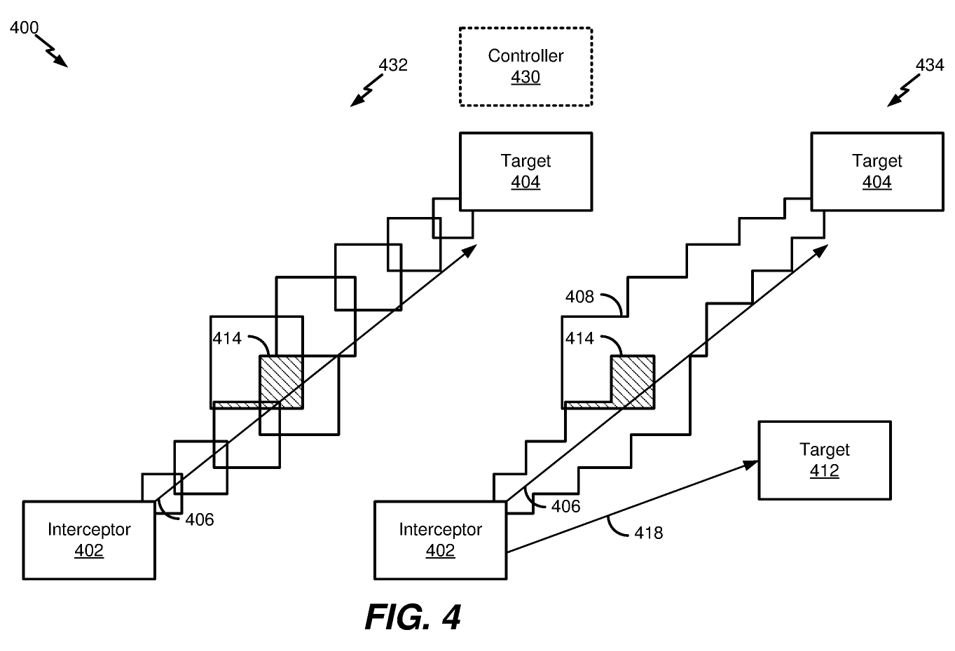

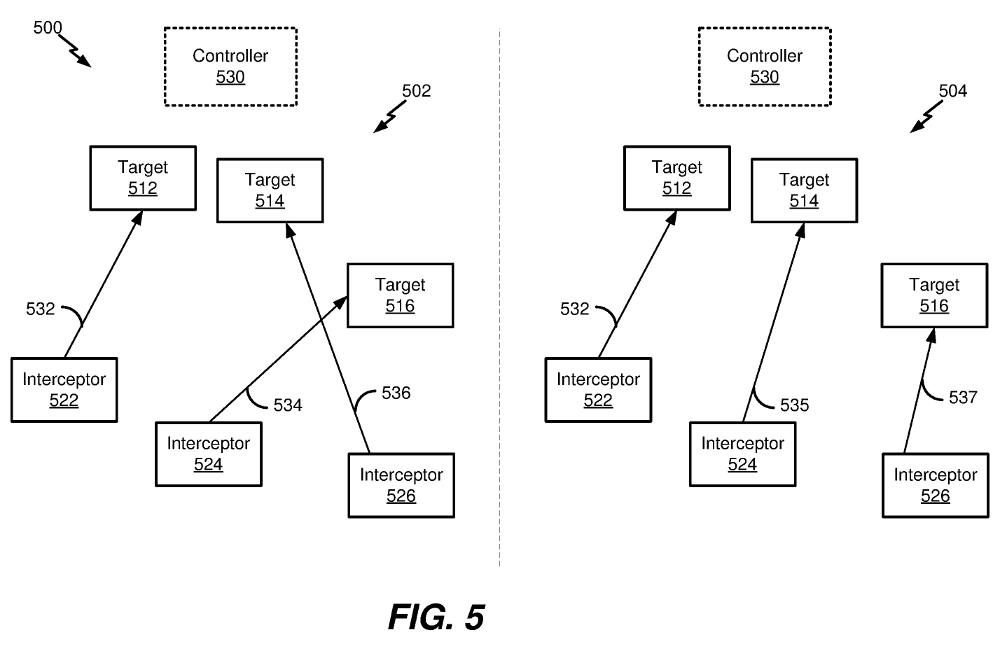

In various implementations, the forward reachability assessment of the first portion 132, the backward reachability assessment of the second portion 134, or both, are performed by various entities. In some implementations, the forward reachability assessment and the backward reachability assessment are performed by the interceptor 102 (e.g., an automobile attempting to reach a location). In some implementations, the forward reachability assessment and the backward reachability assessment are performed by the target 104 (e.g., a pedestrian attempting to summon a taxi). In some implementations, the forward reachability assessment and the backward reachability assessment are performed by the controller 130 (e.g., an air traffic controller directing an aircraft toward an airport or a drone controller directing a drone toward a location). As discussed further below with reference to FIGS. 2-5, in some implementations, a validation route is calculated based on the forward reachability assessment and the backward reachability assessment. In some cases (e.g., when a likelihood of the interceptor 102 reaching the target 104 within a specified time by following the planned route 106 satisfies a reachability threshold), the validation route is the same as the planned route 106. In some cases (e.g., when the likelihood of the interceptor 102 reaching the target 104 within the specified time by following the planned route 106 fails to satisfy a route reachability threshold), the validation route differs from the planned route 106. In some cases, as further discussed below with reference to FIGS. 2 and 3, the validation route is a different (second) planned route from the interceptor 102 to the target 104 (e.g., a modified version of the planned route 106 is used instead). For example, if there is overlap between a forward reachability assessment and a backward reachability assessment, a mean of overlapping locations of reachable sets can be used to construct a different route from the interceptor 102 to the target 104. In some cases, as further discussed below with reference to FIGS. 4 and 5 (e.g., when the likelihood of the interceptor 102 reaching the specified time fails to satisfy the reachability threshold), the validation route is a route to a different target.

In some implementations, the interceptor 102 can reach other locations by the times corresponding to the volumes 110-115. For example, in some cases, the interceptor 102 can reach locations on a side of the interceptor 102 opposite the target 104 by the times corresponding to the volumes 110-115. Similarly, in some implementations, the target 104 can be reached from other locations from the times corresponding to the volumes 120-125. For example, in some cases, the target 104 can be reached from locations on a side of the target 104 opposite the interceptor 102 by the times corresponding to the volumes 120-125. In other words, in some cases, the volumes 110-115, the volumes 120-125, or both, are better depicted surrounding the interceptor 102, the target 104, or both. However, smaller volumes between the interceptor 102 and the target 104 are depicted in the interest of clarity. Although the volumes 110-115 and 120-125 are depicted as squares, in other implementations, volumes of other shapes (e.g., ovals, triangles, trapezoids, etc.) are contemplated. In some cases, calculating square volumes is less computationally expensive, as compared to other shapes. FIGS. 2-4 also only illustrate smaller square volumes in a general direction of the target from the interceptor and vice versa the interest of clarity. However, other shapes and sizes of volumes are similarly contemplated.

FIG. 2 is a diagram that illustrates two additional portions of the first example 100 mixed reachability assessment of FIG. 1 to validate the planned route 106 of travel of the interceptor 102 in association with the target 104. In FIG. 2, the first example 100 includes a third portion 232 and a fourth portion 234. FIG. 2 also shows the controller 130.

The third portion 232 illustrates a mixed reachability assessment in which the forward reachability assessment of the first portion 132 of FIG. 1 is combined with the backward reachability assessment of the second portion 134. In the mixed reachability assessment, intersections 204 (indicated by crosshatching) between the forward reachability assessment and the backward reachability assessment are identified and corresponding probability masses are determined. Because only the intersections 204 are both reachable from the interceptor 102 within respective times and able to reach the target 104 within respective times, computational complexity of the forward reachability assessment and the backward reachability assessment can be reduced by omitting computations corresponding to remaining portions (indicated by unfilled volumes) of the forward reachability zone and the backward reachability zone (e.g., omitting computations corresponding to extraneous potential solutions identified by the forward reachability assessment and the backward reachability assessment).

In some cases, the volumes 110-115 and 120-125 are not the final volumes used to calculate a reachability metric in a mixed reachability assessment. For example, if the volume 115 of the forward reachability assessment overshoots with a final volume of the backward reachability assessment (e.g., the volume 125), overlap is still expected and the interceptor 102 is still expected to reach the target 104, but calculation is not confined to just the forward reachability assessment of the first portion 132 and the backward reachability assessment of the second portion 134.

The fourth portion 234 illustrates a mixed reachability zone 208 formed by a combination of the forward reachability zone and the backward reachability zone. The fourth portion 234 also illustrates the intersections 204. In some implementations, an intersection analysis between the forward reachability zone and the backward reachability zone uses the intersections 204 to generate a reachability metric that indicates a likelihood of the interceptor 102 reaching the target 104 within the specified time. For example, an intersection analysis uses the intersections 204 to identify that the interceptor 102 has a likelihood that satisfies a reachability threshold value to reach the target 104 within the specified time. However, the intersection analysis further uses an amount of overlap between the intersections 204 and the planned route 106 to identify that the planned route 106 fails to satisfy a route reachability threshold. Accordingly, the intersection analysis identifies a different route, a modified route 206, as a validation route. For example, if there is overlap between a forward reachability assessment and a backward reachability assessment, a mean of overlapping locations of reachable sets can be used to construct a different route, the modified route 206, from the interceptor 102 to the target 104. The validation route is used by the interceptor 102 to navigate to the target 104.

As discussed above with reference to FIG. 1, in various implementations, the forward reachability assessment, the backward reachability assessment, or both are performed by various entities, including the interceptor 102, the target 104, or the controller 130. Additionally, the generation of the reachability metric, the intersection analysis, and the generation of the validation route are performed by various entities, including the interceptor 102, the target 104, or the controller 130. In some implementations, when the interceptor 102 does not generate the validation route, the validation route is sent to the interceptor 102 and stored at a memory of the interceptor 102.

FIG. 3 is a diagram that illustrates two portions of a second example 300 mixed reachability assessment to validate a planned route of travel of an interceptor in association with a target. In FIG. 3, the second example 300 includes a first portion 332, a second portion 334, and a controller 330. The first portion 332 and the second portion 334 depict respective assessments performed between an interceptor 302 and a target 304. Additionally, the first portion 332 and the second portion 334 depict a planned route 306 of the interceptor 302. The planned route 306 is depicted as a straight line for simplicity and clarity, but one of ordinary skill would understand that, in some cases, the planned route 306 can be more complicated (e.g., involving turns).

The first portion 332 depicts a mixed reachability assessment in which a forward reachability assessment from the interceptor 302 to the target 304 is combined with a backward reachability assessment from the target 304 to the interceptor 302. The forward reachability assessment identifies volumes 310, 311, 312, and 313. The backward reachability assessment identifies volumes 322, 323, 324, and 325. However, unlike the mixed reachability assessment described above with reference to FIG. 2, the forward reachability assessment of the first portion 332 does not reach from the interceptor 302 all the way to the target 304. Similarly, the backward reachability assessment of the first portion 332 does not reach all the way to the interceptor 302. However, because the forward reachability zone of the volumes 310-313 and the backward reachability zone of the volumes 322-325 both reach a same area, intersections 305 are identified as part of an intersection analysis.

The second portion 334 illustrates a mixed reachability zone 308 formed by a combination of the forward reachability zone of the volumes 310-313 and the backward reachability zone of the volumes 322-325. The second portion 334 also illustrates the intersections 305. In some implementations, an intersection analysis between the forward reachability zone and the backward reachability zone uses the intersections 305 to generate a reachability metric that indicates a likelihood of the interceptor 302 reaching the target 304 within the specified time. For example, an intersection analysis uses the intersections 305 to identify that the interceptor 302 has a likelihood that satisfies a reachability threshold value to reach the target 304 within the specified time. However, the intersection analysis further uses an amount of overlap between the intersections 305 and the planned route 306 to identify that the planned route 306 fails to satisfy a route reachability threshold. In various implementations, one or more actions are performed in response to identifying that the planned route 306 fails to satisfy a route reachability threshold. In some implementations, user feedback is requested. In some cases, the user feedback indicates a modified route, a new target, or both. In some implementations, a different route (e.g., a modified route) that satisfies the route reachability threshold is identified. Accordingly, in some cases, the intersection analysis identifies a different route, a modified route 307, as a validation route. For example, if there is overlap between a forward reachability assessment and a backward reachability assessment, a mean of overlapping locations of reachable sets can be used to construct a different route, the modified route 307, from the interceptor 302 to the target 304. The validation route is used by the interceptor 302 to navigate to the target 304. In some implementations, as further discussed below with reference to FIGS. 4 and 5, a different target is identified instead of a modified route that satisfies the route reachability threshold.

In various implementations, the forward reachability assessment, the backward reachability assessment, or both are performed by various entities, including the interceptor 302, the target 304, or the controller 330. Additionally, the generation of the reachability metric, the intersection analysis, and the generation of the validation route are performed by various entities, including the interceptor 302, the target 304, or the controller 330. In some implementations, when the interceptor 302 does not generate the validation route, the validation route is sent to the interceptor 302 and stored at a memory of the interceptor 302.

FIG. 4 is a diagram that illustrates two portions of a third example 400 mixed reachability assessment to validate a planned route of travel of an interceptor in association with a target. In FIG. 4, the third example 400 includes a first portion 432, a second portion 434, and a controller 430. The first portion 432 and the second portion 434 depict respective assessments performed between an interceptor 402 and a target 404, and, in some cases, a target 412. Additionally, the first portion 432 and the second portion 434 depict a planned route 406 of the interceptor 402. The planned route 406 is depicted as a straight line for simplicity and clarity, but one of ordinary skill would understand that, in some cases, the planned route 406 can be more complicated (e.g., involving turns).

The first portion 432 depicts a mixed reachability assessment in which a forward reachability assessment from the interceptor 402 to the target 404 is combined with a backward reachability assessment from the target 404 to the interceptor 402. However, unlike the mixed reachability assessment described above with reference to FIGS. 2 or 3, the forward reachability assessment considers a different (smaller) area than the backward reachability assessment. In other implementations, the forward reachability assessment considers a larger area than the backward reachability assessment. Similar to the mixed reachability assessment described above with reference to FIG. 3, because the forward reachability zone and the backward reachability zone both reach a same area, intersections 414 are identified as part of an intersection analysis.

The second portion 434 illustrates a mixed reachability zone 408 formed by a combination of the forward reachability zone and the backward reachability zone. The second portion 434 also illustrates the intersections 414. In some implementations, an intersection analysis between the forward reachability zone and the backward reachability zone uses the intersections 414 to generate a reachability metric that indicates a likelihood of the interceptor 402 reaching the target 404 within the specified time. In the second portion 434, although the planned route 406 crosses the intersections 414, an intersection analysis generates a reachability metric that identifies that the interceptor 402 does not have a likelihood that satisfies a reachability threshold value to reach the target 404 within the specified time. In other words, an intersection analysis uses the intersections 414 to identify that, although the planned route 406 has a non-zero likelihood to reach the target 404 within the specified time (depicted by the crossing of the planned route 406 and the intersections 414), the interceptor 402 does not have a likelihood that satisfies a reachability threshold value to reach the target 404 within the specified time. In some cases, when the intersection analysis generates a reachability metric that identifies that the interceptor 402 has no chance to reach the target 404 within the specified time, the reachability metric identifies that the interceptor 402 does not have a likelihood that satisfies a reachability threshold value to reach the target 404 within the specified time.

In various implementations, one or more actions are performed in response to the intersection analysis generating a reachability metric that does not indicate a likelihood of the interceptor 402 reaching the target 404 within the specified time. In some implementations, as described above with respect to FIG. 3, a new route between the interceptor 402 and the target 404 is identified. In some implementations, a new target is automatically identified (e.g., based on automatic identification or user identification of one or more similar targets). In some implementations, user feedback is requested and user feedback is received. In some cases, the user feedback indicates a new planned route, a new target, or both. In cases where a new target is identified (e.g., automatically or by the user feedback), a new (second) planned route is calculated. Accordingly, in some cases, a different route 418 to a different target 412 is identified as a validation route based on the intersection analysis. The validation route is used by the interceptor 402 to navigate to the target 412.

In various implementations, the forward reachability assessment, the backward reachability assessment, or both are performed by various entities, including the interceptor 402, the target 404, the target 412, or the controller 430. Additionally, the generation of the reachability metric, the intersection analysis, and the generation of the validation route are performed by various entities, including the interceptor 402, the target 404, the target 412, or the controller 430. In some implementations, when the interceptor 402 does not generate the validation route, the validation route is sent to the interceptor 402 and stored at a memory of the interceptor 402.

FIG. 5 is a diagram that illustrates two portions of an example 500 mixed reachability assessment to validate a plurality of planned routes of travel of a plurality of interceptors in association with a plurality of targets. In FIG. 5, the example 500 includes a first portion 502 and a second portion 504. The first portion 502 occurs prior to the second portion 504. The first portion 502 and the second portion 504 each depict a plurality of interceptors 522, 524, and 526, a plurality of targets 512, 514, and 516, and a controller 530.

In the first portion 502, the interceptor 522 has a planned route 532 toward the target 512, the interceptor 524 has a planned route 534 toward the target 516, and the interceptor 526 has a planned route 536 toward the target 514. Mixed reachability assessments and intersection analyses are generated for each of the interceptor/target pairs along the respective planned routes 532, 534, and 536. In the first portion 502, similar to the intersection analysis described above with respect to FIG. 4, an intersection analysis identifies that the interceptor 526 does not have a likelihood that satisfies a reachability threshold value to reach the target 514 within a specified time. The planned routes 532-536 are depicted as straight lines for simplicity and clarity, but one of ordinary skill would understand that, in some cases, one or more of the planned routes 532-536 can be more complicated (e.g., involving turns).

In the second portion 504, in response to the intersection analysis identifying that the interceptor 526 does not have a likelihood that satisfies the reachability threshold value to reach the target 514 within the specified time, new validation routes are generated and assigned to the interceptors 522, 524, and 526. In the second portion 504, the interceptor 522 still has the planned route 532 toward the target 512 as a validation route. However, the interceptor 524 has a modified route 535 toward the target 514 as a validation route, and the interceptor 526 has a modified route 537 toward the target 516 as a validation route. In some implementations, new targets, new interceptors, or both, are considered (e.g., the interceptor 522 is sent to a target that is not depicted in FIG. 5) in response to an intersection analysis identifying that an interceptor (e.g., the interceptor 526) does not have a likelihood that satisfies a reachability threshold value, a likelihood that satisfies a route reachability threshold value, or both.

In various implementations, the forward reachability assessment, the backward reachability assessment, or both are performed by various entities, including one or more of the interceptors 522, 524, or 526, one or more of the targets 512, 514, or 516, or the controller 530. Additionally, the generation of the reachability metric, the intersection analysis, and the generation of the validation route are performed by various entities, including one or more of the interceptors 522, 524, or 526, one or more of the targets 512, 514, or 516, or the controller 530. In some implementations, when one or more of the interceptors 522, 524, or 526 do not generate a respective validation route, the validation route is sent to the one or more of the interceptors 522, 524, or 526 and stored at a memory of the one or more of the interceptors 522, 524, or 526.

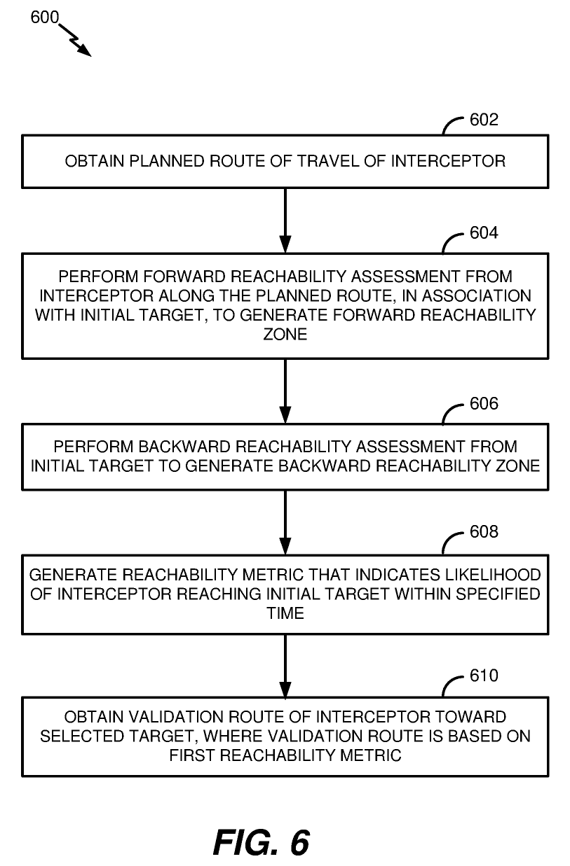

FIG. 6 is a flowchart of a method 600 of validating a planned route of travel of an interceptor in association with a target using a mixed reachability assessment. In some implementations, the method 600 is initiated by one or more processors in response to one or more instructions stored by a computer-readable storage medium. In some implementations, some portions of the method 600 are performed simultaneously, such as blocks 604 and 606. In some implementations, the method 600 is performed by an interceptor. In some implementations, the method 600 is performed by a target. In some implementations, the method 600 is performed by a controller.

The method 600 includes, at block 602, obtaining a planned route of travel of an interceptor. For example, as described with reference to FIG. 1, a planned route 106 of travel of an interceptor 102 is obtained (e.g., generated or received).

The method 600 includes, at block 604, performing a forward reachability assessment from the interceptor along the planned route, in association with an initial target, to generate a forward reachability zone. For example, a forward reachability assessment is performed from the interceptor 102 along the planned route 106, in association with the target 104, to generate a forward reachability zone corresponding to the volumes 110-115 or the volumes 310-313.

The method 600 includes, at block 606, performing a backward reachability assessment from the initial target to generate a backward reachability zone. For example, a backward reachability assessment is performed from the target 104 to generate a backward reachability zone corresponding to the volumes 120-125 or the volumes 322-325. In some cases, backward reachability assessments for multiple targets (e.g., the targets 512-516) are performed simultaneously.

The method 600 includes, at block 608, generating a reachability metric that indicates a likelihood of the interceptor reaching the initial target within a specified time. For example, a reachability metric is generated using the intersections 204 of FIG. 2 or the intersections 305 of FIG. 3, where the reachability metric indicates a likelihood of the interceptor 102 reaching the target 104 within a specified time. In some implementations, generating the reachability metric is performed as part of an intersection analysis.

The method includes, at block 610, obtaining a validation route of the interceptor toward the selected target, where the validation route is based on the reachability metric. For example, in response to a determination that a route reachability metric corresponding to the planned route 106 satisfies a route reachability threshold (a first reachability threshold) as described with reference to FIG. 2, the planned route 106 is obtained as the validation route. In response to the route reachability metric failing to satisfy the route reachability threshold but the reachability metric satisfying a reachability threshold (a second reachability threshold) as described with reference to FIGS. 2 and 3, the modified route 206 or 306 is obtained as the validation route. In response to the reachability metric failing to satisfy the reachability threshold, the different route 418 is obtained as the validation route.

Accordingly, a method of validating a planned route of travel of an interceptor in association with a target using a mixed reachability assessment is depicted. Because the mixed reachability assessment is used, the method 600 is less computationally expensive, as compared to a forward reachability assessment alone or a backward reachability assessment alone. Because the validation route is the same as the planned route as long as the route reachability threshold is satisfied, the route of the interceptor is unchanged by small route changes that do not impact the ability of the interceptor to reach the target within the specified time.

FIG. 7 is a block diagram of a computing environment 700 including a computing device 710 configured to support aspects of computer-implemented methods and computer-executable program instructions (or code) according to the present disclosure. For example, the computing device 710, or portions thereof, is configured to execute instructions to initiate, perform, or control one or more operations described with reference to FIGS. 1-6. In some implementations, the computing device 710 is a portion of the interceptor 102 of FIG. 1. In some implementations, the computing device 710 is a portion of the target 104. In some implementations, the computing device 710 is a portion of the controller 130.

The computing device 710 includes one or more processors 720. The processor(s) 720 are configured to communicate with a system memory 730, one or more storage devices 722, one or more input/output interfaces 724, one or more communications interfaces 726, or any combination thereof. The system memory 730 includes volatile memory devices (e.g., random access memory (RAM) devices), nonvolatile memory devices (e.g., read-only memory (ROM) devices, programmable read-only memory, and flash memory), or both. The system memory 730 stores an operating system 732, which can include a basic input/output system for booting the computing device 710 as well as a full operating system to enable the computing device 710 to interact with users, other programs, and other devices. The system memory 730 stores program data 736, such as the planned route 106, an identified forward reachability zone 740 (e.g., corresponding to the volumes 110-115 of FIG. 1 or the volumes 310-313 of FIG. 3), an identified backward reachability zone 742 (e.g., corresponding to the volumes 120-125 of FIG. 1 or the volumes 322-325 of FIG. 3), a reachability metric 744, and a validation route 746 (e.g., corresponding to the planned route 106 of FIG. 1, the modified route 206 of FIG. 2, the modified route 307 of FIG. 3, or the different route 418 of FIG. 4).

The system memory 730 includes one or more applications 734 (e.g., sets of instructions) executable by the processor(s) 720. As an example, the one or more applications 734 include instructions executable by the processor(s) 720 to initiate, control, or perform one or more operations described with reference to FIGS. 1-6. To illustrate, the one or more applications 734 include instructions executable by the processor(s) 720 to initiate, control, or perform one or more operations to perform a mixed reachability assessment, generate a reachability metric, validate a planned route of travel, or any combination thereof.

In a particular implementation, the system memory 730 includes a non-transitory, computer-readable medium storing the instructions that, when executed by the processor(s) 720, cause the processor(s) 720 to initiate, perform, or control operations to validate a planned route of travel of an interceptor in association with a target using a mixed reachability assessment.

The one or more storage devices 722 include nonvolatile storage devices, such as magnetic disks, optical disks, or flash memory devices. In a particular example, the storage devices 722 include both removable and non-removable memory devices. The storage devices 722 are configured to store an operating system, images of operating systems, applications (e.g., one or more of the applications 734), and program data (e.g., the program data 736). In a particular aspect, the system memory 730, the storage devices 722, or both, include tangible computer-readable media. In a particular aspect, one or more of the storage devices 722 are external to the computing device 710.

The one or more input/output interfaces 724 enable the computing device 710 to communicate with one or more input/output devices 712 to facilitate user interaction. For example, the one or more input/output interfaces 724 can include a display interface, an input interface, or both. For example, the input/output interface 724 is adapted to receive input from a user, to receive input from another computing device, or a combination thereof. In some implementations, the input/output interface 724 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 712 includes one or more user interface devices and displays, including some combination of buttons, keyboards, pointing devices, displays, speakers, microphones, touch screens, and other devices.

The processor(s) 720 are configured to communicate with devices or controllers 714 via the one or more communications interfaces 726. For example, the one or more communications interfaces 726 can include a network interface.

In conjunction with the described systems and methods, an apparatus is disclosed that includes means for storing a first planned route of travel of an interceptor. The apparatus also includes means for processing, configured to: perform a forward reachability assessment for the first interceptor along the first planned route in association with a first target to generate a forward reachability zone; perform a backward reachability assessment from the first target to generate a backward reachability zone; generate a first reachability metric that indicates a likelihood of the first interceptor reaching the first target within a specified time; and in response to the first reachability metric failing to satisfy a reachability threshold: generate a first validation route for the first interceptor, wherein the first validation route is based on the first reachability metric; store the first validation route at the memory; and send the first validation route to the first interceptor.

In some implementations, a non-transitory, computer-readable medium stores instructions that, when executed by one or more processors, cause the one or more processors to initiate, perform, or control operations to perform part or all of the functionality described above. For example, the instructions can be executable to implement one or more of the operations or methods of FIGS. 1–7. In some implementations, part or all of one or more of the operations or methods of FIGS. 1–7 can be implemented by one or more processors (e.g., one or more central processing units (CPUs), one or more graphics processing units (GPUs), one or more digital signal processors (DSPs)) executing instructions, by dedicated hardware circuitry, or any combination thereof.

Further, the disclosure includes embodiments according to the following examples:

According to Example 1, a method includes obtaining a first planned route of travel of an interceptor; performing a forward reachability assessment from the interceptor along the first planned route, in association with an initial target, to generate a forward reachability zone; performing a backward reachability assessment from the initial target to generate a backward reachability zone; generating a first reachability metric that indicates a likelihood of the interceptor reaching the initial target within a specified time; and obtaining a validation route of the interceptor toward a selected target, wherein the validation route is based on the first reachability metric.

Example 2 includes the method of Example 1, further comprising performing an intersection analysis between the forward reachability zone and the backward reachability zone, wherein performing the intersection analysis includes generating the first reachability metric.

Example 3 includes the method of Example 2, wherein generating the first reachability metric comprises excluding regions of the forward reachability zone and the backward reachability zone that do not correspond to intersections indicated by the intersection analysis.

Example 4 includes the method of any of Example 1 to Example 3, wherein the validation route is the same as the first planned route.

Example 5 includes the method of any of Example 1 to Example 4 and further includes determining that the first reachability metric fails to satisfy a first reachability threshold that indicates that the interceptor will fail to reach the initial target within the specified time by following the first planned route.

Example 6 includes the method of Example 5, wherein the validation route is a second planned route of travel of the interceptor, wherein the second planned route is a modified version of the first planned route, and wherein the initial target is the selected target.

Example 7 includes the method of Example 6 and further includes in response to determining that the first reachability metric fails to satisfy the first reachability threshold, requesting user feedback; and receiving the user feedback.

Example 8 includes the method of Example 7, wherein obtaining the validation route comprises receiving the second planned route from the user feedback.

Example 9 includes the method of Example 7, wherein obtaining the validation route comprises calculating the second planned route in response to the user feedback.

Example 10 includes the method of any of Example 1 to Example 9 and further includes determining that the first reachability metric fails to satisfy a second reachability threshold that indicates that the interceptor cannot reach the initial target within the specified time.

Example 11 includes the method of Example 10 and further includes, in response to determining that the first reachability metric fails to satisfy the second reachability threshold, obtaining a new target for the interceptor, wherein the selected target is the new target.

Example 12 includes the method of any of Example 1 to Example 11 and further includes, in response to the validation route differing from the first planned route, sending the validation route to the interceptor, wherein obtaining the first planned route, generating the first reachability metric, and obtaining the validation route are performed by a controller remote from the interceptor.

Example 13 includes the method of any of Example 1 to Example 12 and further includes, in response to the validation route differing from the first planned route, sending the validation route to the interceptor, wherein obtaining the first planned route, generating the first reachability metric, and obtaining the validation route are performed by the initial target.

Example 14 includes the method of any of Example 1 to Example 13, wherein obtaining the first planned route, generating the first reachability metric, and obtaining the validation route are performed by the interceptor.

According to Example 15, an interceptor includes a memory configured to store a first planned route of travel; and one or more processors coupled to the memory and configured to perform a forward reachability assessment along the first planned route in association with a target to generate a forward reachability zone; perform a backward reachability assessment from the target to generate a backward reachability zone; generate a reachability metric that indicates a likelihood of reaching the target within a specified time; and in response to the reachability metric failing to satisfy a reachability threshold: generate a validation route, wherein the validation route is based on the reachability metric; and store the validation route at the memory.

Example 16 includes the interceptor of Example 15, wherein the reachability metric is associated with a probability mass of overlaps between the forward reachability assessment and the backward reachability assessment.

Example 17 includes the interceptor of Example 15 or Example 16, wherein the one or more processors are configured to perform the backward reachability assessment in association with a location of the interceptor.

According to Example 18, a controller includes a memory configured to store a first planned route of travel of a first interceptor; and one or more processors coupled to the memory and configured to perform a forward reachability assessment for the first interceptor along the first planned route in association with a first target to generate a forward reachability zone; perform a backward reachability assessment from the first target to generate a backward reachability zone; generate a first reachability metric that indicates a likelihood of the first interceptor reaching the first target within a specified time; and in response to the first reachability metric failing to satisfy a reachability threshold: generate a first validation route for the first interceptor, wherein the first validation route is based on the first reachability metric; store the first validation route at the memory; and send the first validation route to the first interceptor.

Example 19 includes the controller of Example 18, wherein the first validation route is toward a second target rather than the first target.

Example 20 includes the controller of Example 18 or Example 19, wherein the one or more processors are further configured to generate a plurality of reachability metrics for a plurality of interceptors, wherein generation of the plurality of reachability metrics comprises generation of the first reachability metric; and generate a plurality of validation routes toward a plurality of targets, wherein generation of the plurality of validation routes comprises generation of the first validation route, and wherein at least one validation route of the plurality of validation routes is toward the first target.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A method comprising:
obtaining a first planned route of travel of an interceptor;
performing a forward reachability assessment from the interceptor along the first planned route, in association with an initial target, to generate a forward reachability zone;
performing a backward reachability assessment from the initial target to generate a backward reachability zone;
generating a first reachability metric that indicates a likelihood of the interceptor reaching the initial target within a specified time; and
obtaining a validation route of the interceptor toward a selected target, wherein the validation route is based on the first reachability metric.

2. The method of claim 1, further comprising performing an intersection analysis between the forward reachability zone and the backward reachability zone, wherein performing the intersection analysis includes generating the first reachability metric.

3. The method of claim 2, wherein generating the first reachability metric comprises excluding regions of the forward reachability zone and the backward reachability zone that do not correspond to intersections indicated by the intersection analysis.

4. The method of claim 1, wherein the validation route is the same as the first planned route.

5. The method of claim 1, further comprising determining that the first reachability metric fails to satisfy a first reachability threshold that indicates that the interceptor will fail to reach the initial target within the specified time by following the first planned route.

6. The method of claim 5, wherein the validation route is a second planned route of travel of the interceptor, wherein the second planned route is a modified version of the first planned route, and wherein the initial target is the selected target.

7. The method of claim 6, further comprising:
in response to determining that the first reachability metric fails to satisfy the first reachability threshold, requesting user feedback; and
receiving the user feedback.

8. The method of claim 7, wherein obtaining the validation route comprises receiving the second planned route from the user feedback.

9. The method of claim 7, wherein obtaining the validation route comprises calculating the second planned route in response to the user feedback.

10. The method of claim 5, further comprising determining that the first reachability metric fails to satisfy a second reachability threshold that indicates that the interceptor cannot reach the initial target within the specified time.

11. The method of claim 10, further comprising, in response to determining that the first reachability metric fails to satisfy the second reachability threshold, obtaining a new target for the interceptor, wherein the selected target is the new target.

12. The method of claim 1, further comprising, in response to the validation route differing from the first planned route, sending the validation route to the interceptor, wherein obtaining the first planned route, generating the first reachability metric, and obtaining the validation route are performed by a controller remote from the interceptor.

13. The method of claim 1, further comprising, in response to the validation route differing from the first planned route, sending the validation route to the interceptor, wherein obtaining the first planned route, generating the first reachability metric, and obtaining the validation route are performed by the initial target.

14. The method of claim 1, wherein obtaining the first planned route, generating the first reachability metric, and obtaining the validation route are performed by the interceptor.

15. An interceptor comprising:
a memory configured to store a first planned route of travel; and
one or more processors coupled to the memory and configured to:
perform a forward reachability assessment along the first planned route in association with a target to generate a forward reachability zone;
perform a backward reachability assessment from the target to generate a backward reachability zone;
generate a reachability metric that indicates a likelihood of reaching the target within a specified time; and
in response to the reachability metric failing to satisfy a reachability threshold:
generate a validation route, wherein the validation route is based on the reachability metric; and
store the validation route at the memory.

16. The interceptor of claim 15, wherein the reachability metric is associated with a probability mass of overlaps between the forward reachability assessment and the backward reachability assessment.

17. The interceptor of claim 15, wherein the one or more processors are configured to perform the backward reachability assessment in association with a location of the interceptor.

18. A controller comprising:
a memory configured to store a first planned route of travel of a first interceptor; and
one or more processors coupled to the memory and configured to:
perform a forward reachability assessment for the first interceptor along the first planned route in association with a first target to generate a forward reachability zone;
perform a backward reachability assessment from the first target to generate a backward reachability zone;
generate a first reachability metric that indicates a likelihood of the first interceptor reaching the first target within a specified time; and
in response to the first reachability metric failing to satisfy a reachability threshold:
generate a first validation route for the first interceptor, wherein the first validation route is based on the first reachability metric;
store the first validation route at the memory; and
send the first validation route to the first interceptor.

19. The controller of claim 18, wherein the first validation route is toward a second target rather than the first target.

20. The controller of claim 19, wherein the one or more processors are further configured to:
generate a plurality of reachability metrics for a plurality of interceptors, wherein generation of the plurality of reachability metrics comprises generation of the first reachability metric; and
generate a plurality of validation routes toward a plurality of targets, wherein generation of the plurality of validation routes comprises generation of the first validation route, and wherein at least one validation route of the plurality of validation routes is toward the first target.
